(19) United States
(12) Patent Application Publication
(10) Pub. No.: US 2026/0012127 A1
(43) Pub. Date: Jan. 8, 2026

(54) SOLAR MODULE MOUNTING BRACKET FOR TRACKER TORQUE TUBE

(71) Applicant: APA SOLAR, LLC, Ridgeville Corners, OH (US)

(72) Inventors: Josh Von Deylen, Bryan, OH (US); Joseph Von Deylen, Whitehouse, OH (US); Shawn Jeremy Ramey, Ney, OH (US); Richard Alan Roth, Archbold, OH (US); Erik Steven Shinabery, Bryan, OH (US)

(21) Appl. No.: 19/261,394

(22) Filed: Jul. 7, 2025

Related U.S. Application Data
(60) Provisional application No. 63/667,993, filed on Jul. 5, 2024.

(51) Int. Cl. H02S 20/32

(52) U.S. Cl. CPC H02S 20/32

(57) ABSTRACT

A solar module mounting system designed for enhanced efficiency and reliability in photovoltaic installations involving tracker torque tubes. The system features a solar module bracket comprising a central panel, first side panel, and second side panel that together form a U-shaped configuration defining a channel for receiving a back rail of a solar panel module. The bracket includes attachment portions with retention tabs and deflection arms that temporarily secure the solar panel module during installation. A wedge clip formed from unibody construction with spaced-apart arms provides securement by passing through aligned openings in the side panels and mounting slots in the back rail. The wedge clip is tapered and compressible, allowing insertion in a compressed state before expanding to create a wedging action that locks the module in place. A mounting portion projects downwardly from the central panel for attachment to tracker torque tubes via U-bolts.

### CROSS-REFERENCE TO RELATED APPLICATIONS

This application claims the benefit of U.S. Provisional Application No. 63/667,993, filed on Jul. 5, 2024. The entire disclosure of the above application is incorporated herein by reference.

### FIELD

The present technology relates to solar energy systems and, more particularly, to apparatuses and methods for mounting solar modules onto tracking systems.

### INTRODUCTION

This section provides background information related to the present disclosure which is not necessarily prior art.

Solar module mounting systems can secure photovoltaic panels while accommodating tracking system requirements and diverse installation conditions. However, certain mounting approaches present several fundamental problems that limit solar installation effectiveness. Installation complexity can create operational challenges. A mounting system requires alignment and manual labor to achieve proper stability and performance, making installation time-consuming and costly. The rigid nature of these systems accelerates mechanical wear, necessitating frequent maintenance to preserve functionality.

Environmental adaptability remains problematic across varying terrain and conditions. Certain systems struggle to accommodate uneven ground while maintaining optimal panel orientation, resulting in reduced energy capture as panels cannot adjust to maximize solar exposure throughout operational cycles. Mechanical reliability issues can plague existing clip-based mounting mechanisms. Integration difficulties with tracking technologies can compound these problems. Complex mechanisms required for solar tracking functionality are prone to failures and require substantial maintenance investments, limiting practical deployment in cost-sensitive applications.

Accordingly, there is a continuing need for an improved solar module mounting system and method that addresses these challenges and offers enhanced adaptability to various installation environments, case of installation and maintenance including reduced installation time and minimized risk of dislodgement under load, and robust integration with solar tracking technologies.

### SUMMARY

In concordance with the instant disclosure, an improved solar module mounting system and method that offers enhanced adaptability to various installation environments, case of installation and maintenance including reduced installation time and minimized risk of dislodgement under load, and robust integration with solar tracking technologies has surprisingly been discovered.

The present technology includes articles of manufacture, systems, and processes that relate to the efficient mounting, alignment, and tracking of photovoltaic modules on solar energy systems, enhancing energy capture and operational stability.

In one embodiment, a solar module bracket for mounting a solar panel module having a back rail can include a central panel, a first side panel, and a second side panel that together form a U-shaped configuration. The first side panel and the second side panel can each extend from an edge of the central panel and can be disposed along a length of the central panel, and the central panel, first side panel, and second side panel collectively define a channel. The first side panel can have an attachment portion that can include a retention tab and an opening, wherein an edge of the retention tab can be cut out from the side panel. At a free end adjacent to the opening there can be a deflection arm that points perpendicular from the retention tab into the channel. A wedge clip can be selectively received by the opening of the attachment portion to secure the solar panel module within the bracket. The configuration can allow for efficient mounting of a solar panel module while providing both a temporary and a permanent securing mechanism through the attachment portion and wedge clip system.

In another embodiment, a method for mounting a solar panel module can include providing a solar module bracket according to the structural configuration described above, along with providing a tracker torque tube, U-bolt and fasteners, and a solar panel module having a back rail with mounting slots. The method can include positioning the solar module bracket adjacent to the tracker torque tube such that a mounting portion that projects downwardly from the central panel receives the tracker torque tube. The U-bolt can be disposed around the tracker torque tube and through an aperture in a landing of the mounting portion. The method can include securing the U-bolt to the solar module bracket using fasteners, placing the solar panel module into the channel of the bracket, sliding the solar panel module laterally or horizontally to engage the deflection arm with a mounting slot for temporary securing, and inserting the wedge clip through the opening and mounting slot to permanently secure the solar panel module within the bracket. The method can provide a systematic approach to installing a solar panel module that ensures both optimal alignment and secure attachment to the tracker system.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top perspective view of a solar module mounting bracket for a tracker torque tube;

FIG. 2 is a bottom perspective view thereof;

FIG. 3 is a front elevational view thereof;

FIG. 4 is a right-side elevational view thereof;

FIG. 5 is a top plan view thereof;

FIG. 6 is a perspective view of the solar module bracket for a torque tube shown installed on a solar panel module;

FIG. 7 is an exploded perspective view thereof;

FIG. 8 is a perspective view of the solar module bracket depicted attached to the torque tube and removed from the solar module;

FIG. 9 is a perspective view of the solar module bracket of FIG. 8, attached to the solar module;

FIG. 10 is an enlarged perspective view of the solar module bracket, depicting an attachment portion and a wedge clip engaged on a back rail of the solar module;

FIG. 11 is another enlarged perspective view of the solar module bracket, depicting an attachment portion and a wedge clip engaged on a back rail of the solar module;

FIG. 12 is an cross sectional, perspective view of the solar module bracket, depicting an attachment portion on a back rail of the solar module;

FIG. 13 is a perspective view of the wedge clip according to one embodiment of the present disclosure; and

FIGS. 14A-14B are flow charts depicting a method of installation for the solar module bracket, according to a further embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

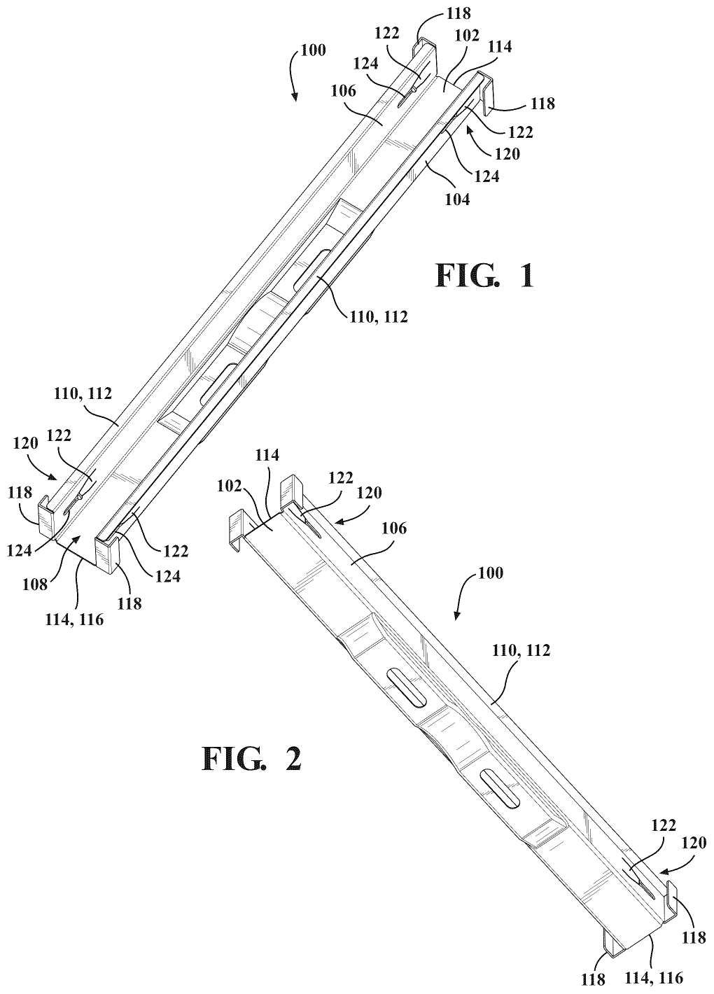

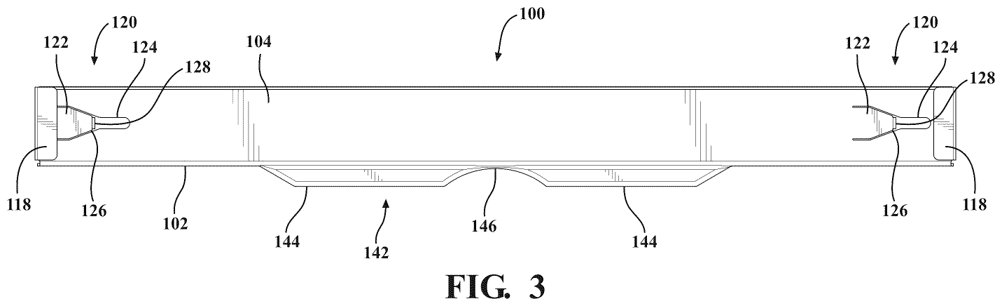

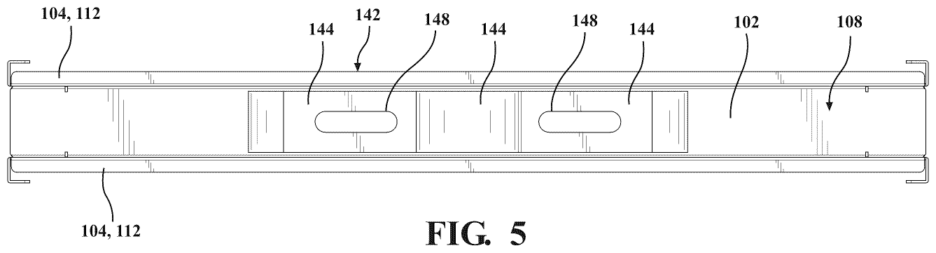

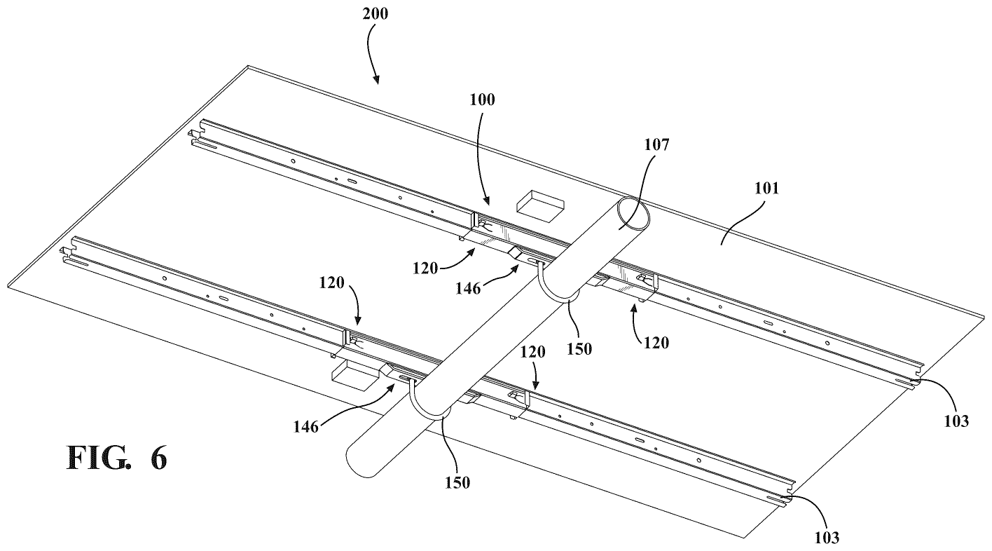

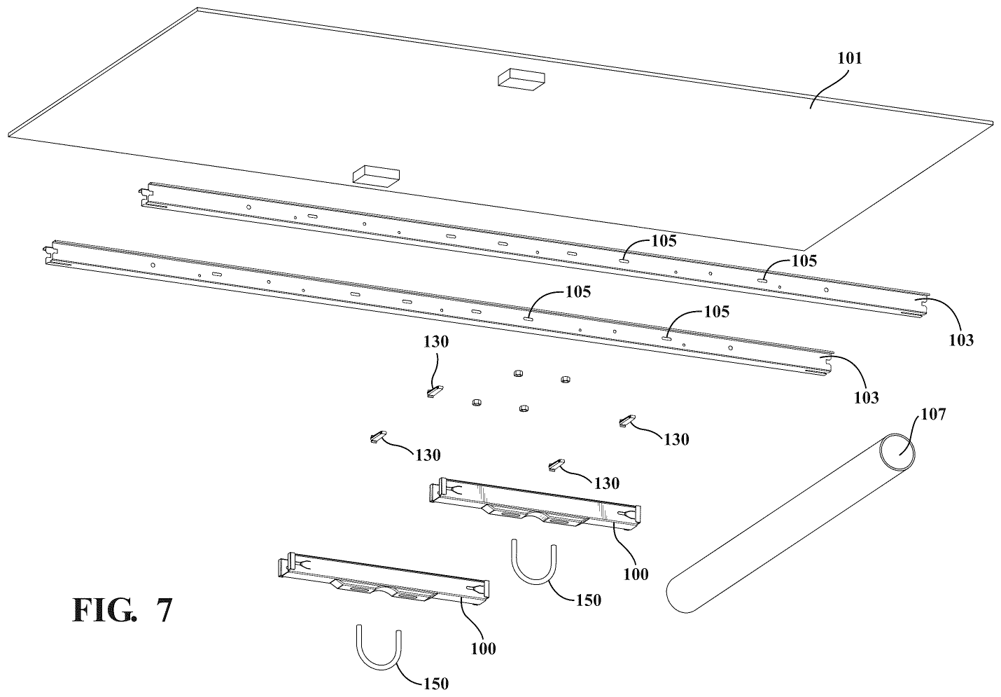

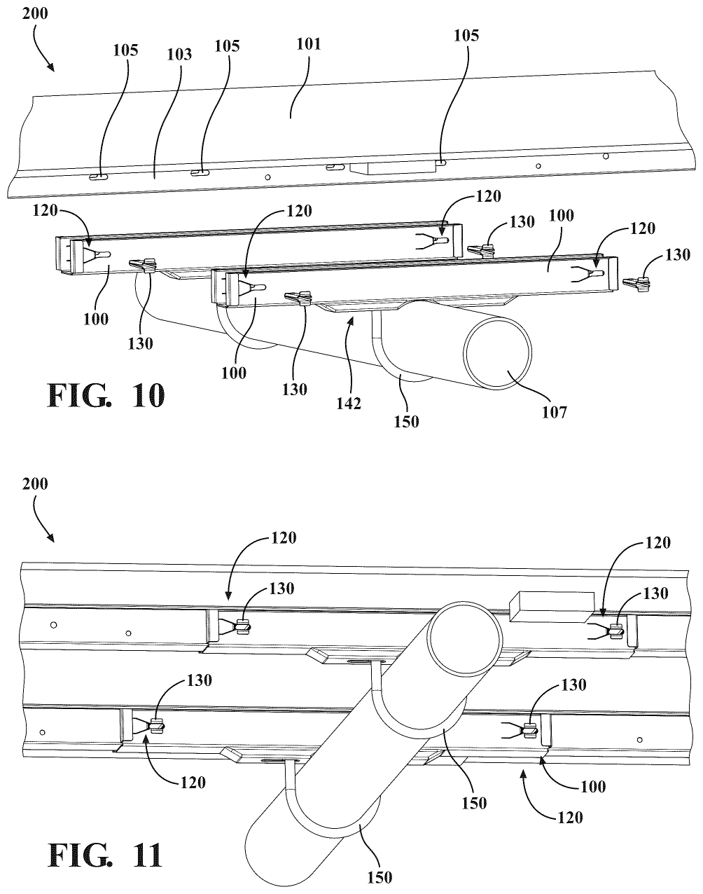

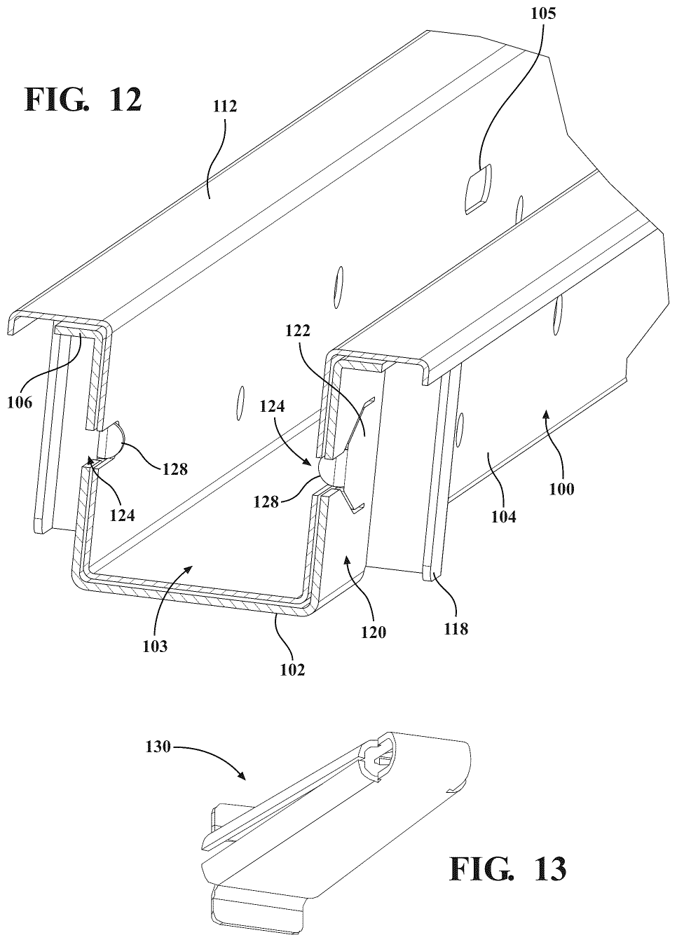

With reference to FIGS. 1-13, a solar module bracket 100 is shown. The solar module bracket 100 can be configured for mounting solar panel modules 101 onto a tracker torque tube 107 in solar panel installation. The solar panel modules 101 can include back rails 103. The back rails 103 can serve as mounting points for the back of the solar panel module 101, providing structural attachment interfaces for securing the modules 101 to mounting systems. The back rails 103 can include one or more mounting slots 105 that facilitate engagement with mounting brackets and hardware. In some embodiments, the mounting slots can be oval slots formed through the back rails 103, which can provide flexibility in positioning and alignment during installation while maintaining secure attachment to the mounting system. A skilled artisan can select a suitable shape for the mounting slots within the scope of the present disclosure.

The solar module bracket 100 can be constructed from durable materials suitable for continuous exposure to environmental elements encountered in outdoor solar installations. In some embodiments, the solar module bracket 100 can be formed from corrosion-resistant materials that maintain structural integrity and functionality over extended operational periods. The material selection can ensure that the solar module bracket 100 withstands various weather conditions, temperature fluctuations, and environmental stresses while maintaining secure engagement with the back rail of the solar panel module 101. Additionally, the solar module bracket 100 can be coated with a protective finish to enhance durability and reduce wear from environmental exposure, thereby extending the operational lifespan of the solar module bracket 100.

The solar module bracket 100 can include a central panel 102, a first side panel 104, and a second side panel 106 that together can form a U-shaped configuration. In this U-shaped configuration, the side panels 104, 106 can each extend from an edge of the central panel 102 and can each be disposed along a length of the central panel 102. The central panel 102, first side panel 104, and second side panel 106 can collectively define a channel 108 that can receive a back rail 103 of a solar panel module 101.

The central panel 102 can have a length and a width, wherein the central panel 102 can be longer than the central panel 102 is wide. This elongated configuration can allow more length of the bracket to extend along the back rail 103 of the solar panel module 101, which can provide enhanced support and stability for the solar panel module 101. The extended length can distribute the mounting forces more effectively along the back rail 103, thereby improving the structural integrity of the installation and reducing stress concentrations that might otherwise occur with shorter mounting brackets. The dimensions of the channel 108 (e.g., the length and the width) can be determined based on the dimensions of the solar module to ensure proper fit and secure mounting.

Each of the first side panel 104 and the second side panel 106 can have a top edge 110. The top edge 110 of each side panel can have a flange 112. The flange 112 can be perpendicular to the respective side panel 104, 106. The flange 112 can abut a portion of the back rail 103 where the solar module bracket 100 is engaged on the back rail 103 of the solar panel module 101. The flange 112 can optimize structural integrity by distributing the weight and mounting forces of the solar panel module 101 across multiple contact points rather than concentrating the load at one particular location on the side panels 104, 106. The flanges 112 can provide additional bearing surfaces that can enhance the overall stability and load distribution of the solar module bracket 100. The central panel 102 can also have free edges 114 on either terminal end 116. Each free edge 114 can have an L-shaped flange 118 extending outwardly therefrom. The L-shaped flange 118 can optimize structural integrity to the side panels 104, 106 and provide additional surface contact area between the solar module bracket 100 and the solar panel module 101. This configuration can enhance the load distribution and bearing capacity of the mounting system by creating additional contact points between the bracket and the back rail 103 of the solar panel module 101, thereby reducing stress concentrations at the terminal ends of the central panel 102.

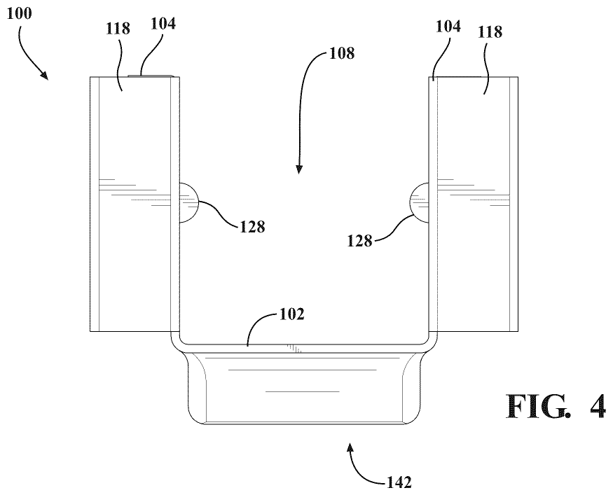

Each of the first side panel 104 and the second side panel 106 can include an attachment portion 120. The attachment portion 120 can be used to secure the solar module bracket 100 in place on the back rail 103 of the solar panel module 101. The attachment portion 120 can include a retention tab 122 and an opening 124. An edge of the retention tab 122 can be cut out from the side panel 104, 106 and at a free end 126 adjacent to the opening 124 there can be a deflection arm 128 that points perpendicular from the retention tab 122 into the channel 108. In operation, the solar module bracket 100 can be placed onto the back rail 103, the back rail 103 can contact the retention tab 122 causing the deflection arm 128 to be urged outwardly from the channel 108. The retention tab 122 can snap into place into mounting slots 105 on the back rail 103 when the retention tab 122 is aligned with the mounting slot 105, and the resilient force provided by the deflection arm 128 urges the retention tab 122 into the mounting slot 105 thereby locking the solar module bracket 100 to the back rail 103. In the embodiment shown in FIG. 4, the retention tab has a rounded profile to facilitate the back rail 103 causing the deflection arm 128 to be urged outwardly from the channel 108.

Each of the first side panel 104 and the second side panel 106 can have the attachment portion 120 with the attachment portion 120 of the first side panel 104 aligned with the attachment portion 120 of the second side panel 106. Furthermore, the back rail 103 can be positioned in the solar module bracket 100 to align each opening 124 of the attachment portion 120 on the first side panel 104 and the second side panel 106 with the mounting slots 105 formed in the back rail 103. The aligned openings 124 and mounting slots 105 can receive a wedge clip 130 that can pass through both the openings in the side panels 104, 106 and the mounting slots 105 in the back rail 103 to secure the solar panel module 101 within the solar module bracket 100.

In one embodiment, for example as shown in FIGS. 1-10, the solar module bracket 100 can include two pairs of attachment portions 120, disposed adjacent to the terminal ends 116 of the solar module bracket 100. However, the location and number of attachment portions 120 can be determined based on the back rail 103 of the solar panel module 101. The attachment portions 120 must correspond to a mounting slot 105 on the back rail 103, but otherwise, a skilled artisan can select suitable locations based on the size of the back rail 103 and solar panel module 101. Advantageously, this flexibility in positioning can allow the solar module bracket 100 to accommodate various solar panel module 101 configurations while maintaining secure attachment through proper alignment of the attachment portions 120 with the corresponding mounting slots 105 in the back rail 103.

The wedge clip 130 can have dimensions that generally correspond to those of the mounting slot 105 and the openings 124. As such, the wedge clip 130 can have an oval cross section that can match the configuration of the oval slots formed through the back rails 103. This dimensional correspondence can ensure proper fit and engagement when the wedge clip 130 can be inserted through the aligned openings 124 in the side panels and the mounting slots 105 in the back rail 103 to secure the solar panel module within the solar module bracket 100.

The wedge clip 130 can be formed from a unibody construction having a closed end and an open end, where the wedge clip 130 can include a first arm 132 and a second arm 134 that can be integrally connected at the closed end and that can be spaced apart from one another at the open end. Adjacent to the connected end of the wedge clip 130, the first arm 132 can have a spring tab 138 that can extend at an angle outwardly from the first arm 132. The wedge clip 130 can be tapered such that the wedge clip 130 can get wider from the closed end to the open end, creating a gradual increase in cross-sectional area along the length of the wedge clip 130, with a longitudinal split 136, formed by a spacing between the first arm 132 and the second arm 134, increasing along the length of the wedge clip 130. The longitudinal split 136 along the length of the wedge clip 130 can allow the first arm 132 and the second arm 134 of the wedge clip 130 to be compressed together when pressure is applied. When the wedge clip 130 is compressed, the first arm 132 and the second arm 134 can be brought together, effectively closing the longitudinal split 136 and reducing the taper and thereby the overall width of the wedge clip 130 for insertion through the aligned openings 124 and mounting slots 105. During this compression and insertion process, the spring tab 138 can be configured to selectively deform elastically when subjected to compressive forces from the side wall during insertion through the openings 124. The wedge clip 130 can also be self-biased so when the wedge clip 130 is not compressed by the side wall, the wedge clip 130 can automatically return to the tapered shape due to the inherent spring properties of the material and the integral construction of the arms 132, 134 at the closed end, with the first arm 132 and the second arm 134 returning to the spaced-apart positions.

The unibody configuration can allow the wedge clip 130 to be compressed and inserted into the aligned openings 124 and mounting slots 105 in a compressed state, and then once received in the aligned openings 124 and mounting slots 105, the wedge clip 130 can expand back to the tapered configuration to create the wedge action that can secure the wedge clip 130 into the solar module bracket 100. When the spring tab 138 clears the final opening 124, the spring tab 138 can automatically return to an extended configuration due to the inherent elastic properties of the material. Once the spring tab 138 returns to the extended configuration, the spring tab 138 can create a mechanical interference that can militate against withdrawal of the wedge clip 130 through the opening 124 by engaging with the surface of the side panel 104, 106 adjacent to the opening 124. This retention mechanism can provide additional security by militating against inadvertent removal of the wedge clip 130 once the wedge clip 130 has been fully inserted through the aligned openings 124 and mounting slots 105, thereby ensuring permanent securement of the solar panel module 101 to the solar module bracket 100. The spring tab 138 can function as a one-way retention feature that allows insertion but resists extraction, creating a positive locking engagement of the wedge clip 130 in the solar module bracket 100 and the solar panel module 101. The tapered nature of the wedge clip 130 combined with the compressible longitudinal split 136 can provide a secure wedging action that can lock the solar panel module 101 within the solar module bracket 100 by expanding within the aligned apertures once inserted.

On the open side of the wedge clip 130, each end of the first arm 132 and second arm 134 can have retention flanges 140 that can extend substantially orthogonal to each of the first arm 132 and second arm 134. The retention flanges 140 can ensure that the wedge clip 130 can be stopped from being inserted too far through the openings 124 and mounting slots 105. This configuration can allow the wedge clip 130 to move forward enough to engage the spring tab 138, but not substantially further, thus locking the wedge clip 130 in place. The retention flanges 140 can function as insertion stops that can create a mechanical interference with the exterior surfaces of the side panels 104, 106 when the wedge clip 130 reaches the proper insertion depth, thereby militating against over-insertion while ensuring that the retention tab 122 can clear the final opening 124 and spring back to the extended configuration for securement to the solar module bracket 100.

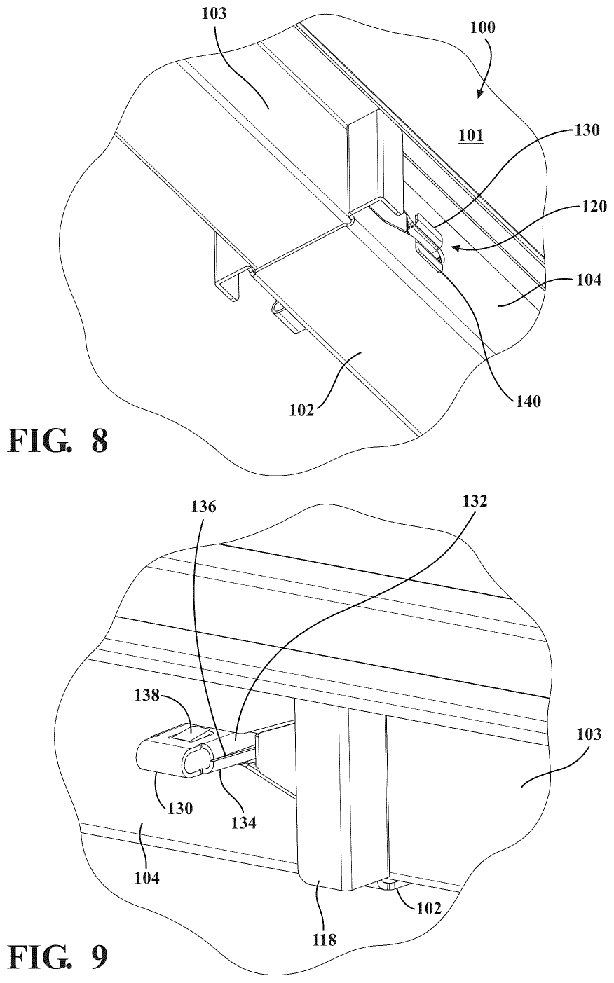

With renewed reference to FIGS. 8-9, the central panel 102 can have a mounting portion 142 to allow the solar module bracket 100 to be mounted to a torque tube 107. The mounting portion 142 can project downwardly from the central panel 102. The mounting portion 142 can include a pair of landings 144 separated by an arcuate portion 146. The arcuate portion 146 can have dimensions that can match those of the torque tube 107 such that the arcuate portion 146 can rest on the torque tube 107. This configuration can provide a stable mounting interface between the solar module bracket 100 and the torque tube 107, with the arcuate portion 146 conforming to the cylindrical shape of the torque tube 107 to distribute mounting loads effectively across the contact surface. The pair of landings 144 can provide additional support and stability for the mounting connection while maintaining optimal alignment of the solar module bracket 100 on the torque tube 107.

Each of the landings 144 can have apertures 148. The apertures 148 can each receive an end of a U-bolt 150. The U-bolt 150 can be secured to the solar module bracket 100 via a fastener, such as a nut, for example. Importantly, the mounting portion 142 can project downwardly from the central panel 102, which can allow the U-bolt 150 to be secured within the landings 144 without entering the channel 108. This configuration can allow the solar module bracket 100 to simultaneously receive the back rail 103 and the U-bolt 150 without interference between hardware for the mounting bracket 100 and the solar panel module 101. The downward projection of the mounting portion 142 can create sufficient clearance between the U-bolt attachment points and the channel 108, thereby maintaining the structural integrity of both the mounting connection to the torque tube 107 and the secure engagement of the back rail 103 within the solar module bracket 100.

With continued reference to FIGS. 8-9, a solar panel installation system 200 can include one or more solar module brackets 100. In the installed state, the U-bolt 150 can be disposed around the tracker torque tube 107 and can be secured through the apertures 148 in the landings 144 of a mounting portion 142 that can project downwardly from the central panel 102. The back rail 103 can be positioned within the channel 108 of the solar module bracket 100, with the solar panel module 101 having been slid laterally or horizontally to engage the attachment portions 120. The deflection arms 128 of the attachment portions 120 can be engaged with mounting slots 105 on the back rail 103, temporarily securing the solar panel module 101 to the solar module bracket 100. The wedge clips 130 can be inserted through the openings 124 of the solar module bracket 100 and the mounting slots 105 of the back rail 103 to secure the solar panel module 101 within the solar module bracket 100. The wedge clips 130 can be formed from a unibody construction with a first arm 132 and a second arm 134 that can be spaced apart and tapered, creating a wedging action when inserted that can lock the solar panel module 101 in place. The spring tabs 138 on the wedge clips 130 can have engaged with the surfaces of the side panels 104, 106 to militate against withdrawal of the wedge clips 130.

Multiple solar module brackets 100 can be installed on the single tracker torque tube 107 to accommodate multiple solar panel modules 101 within the system 200, with the number of brackets 100 determined based on the specific installation requirements and the length of the tracker torque tube 107. The modular design of the solar module bracket 100 can allow for flexible configuration of solar panel installations 200, where additional brackets 100 can be positioned along the length of the tracker torque tube 107 as needed to support the desired number of solar panel modules 101. Each solar module bracket 100 can be independently secured to the tracker torque tube 107 using the U-bolt 150 and the mounting portion 142 configuration, allowing for precise spacing and alignment of multiple solar panel modules along the torque tube. The scalable nature of the system 200 can accommodate various installation sizes, from small residential arrays to large commercial solar farms, by simply adding more solar module brackets 100 along the tracker torque tube 107. A skilled artisan can select a suitable configuration within the scope of the present disclosure.

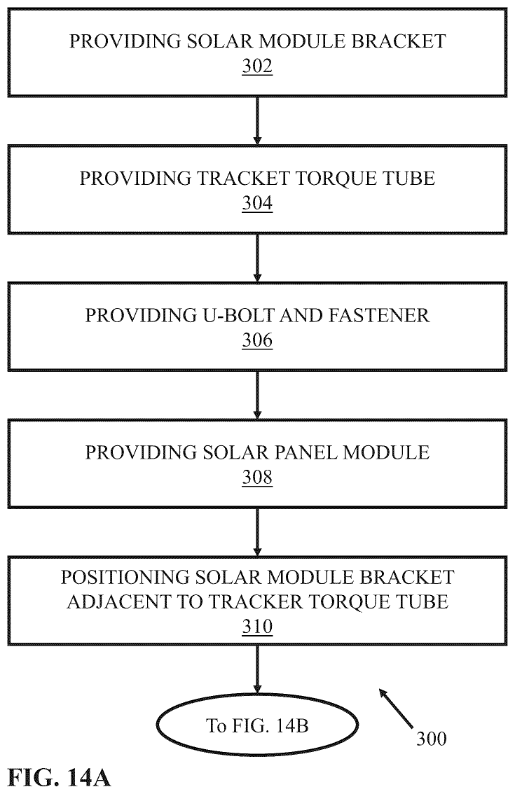

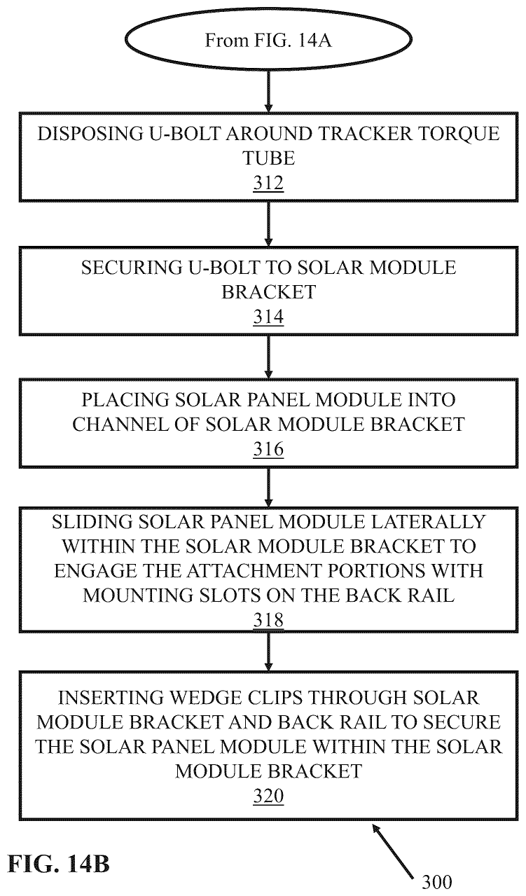

With reference to FIGS. 14A-14B, a method 300 of installing the solar module bracket 100 can include a step 302 of providing the solar module bracket 100 having a central panel 102, a first side panel 104, and a second side panel 106 that together can form a U-shaped configuration. The method 300 can include a step 304 of providing a tracker torque tube 107 for mounting the solar module bracket 100. The method 300 can include a step 306 of providing a U-bolt 150 and fasteners for securing the solar module bracket 100 to the tracker torque tube 107. The method 300 can include a step 308 of providing a solar panel module 101 having a back rail 103 with mounting slots 105.

The method 300 can include a step 310 of positioning the solar module bracket 100 adjacent to the tracker torque tube 107 such that the mounting portion 142 that can project downwardly from the central panel 102 can receive the tracker torque tube 107 within the arcuate portion 146. The method 300 can include a step 312 of disposing the U-bolt 150 around the tracker torque tube 107 and through the apertures 148 in the landings 144 of the mounting portion 142. The method 300 can include a step 314 of securing the U-bolt 150 to the solar module bracket 100 using fasteners to mount the bracket to the tracker torque tube 107.

The method 300 can include a step 316 of placing the solar panel module 101 into the channel 108 of the solar module bracket 100 such that the back rail 103 can be positioned within the channel 108. The method 300 can include a step 318 of sliding the solar panel module 101 laterally or horizontally within the solar module bracket 100 to engage the deflection arms 128 of the attachment portions 120 with the mounting slots 105 on the back rail 103, thereby temporarily securing the solar panel module 101 to the solar module bracket 100.

The method 300 can include a step 320 of inserting wedge clips 130 through the openings 124 of the solar module bracket 100 and the mounting slots 105 of the back rail 103 to secure the solar panel module 101 within the solar module bracket 100. The wedge clips 130 can be compressed during insertion and can expand back to the tapered configuration to create the wedging action that can lock the solar panel module 101 in place, with the spring tabs 138 engaging to prevent withdrawal of the wedge clips 130.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A solar module bracket for mounting a solar panel module having a back rail, comprising:
a central panel, a first side panel, and a second side panel, the first side panel and the second side panel each extend from an edge of the central panel and are disposed along a length of the central panel to define a channel and form a cross section having a generally U-shape;
the first side panel having an attachment portion including a retention tab and an opening, wherein an edge of the retention tab is cut out from the side panel and at a free end adjacent to the opening there is a deflection arm that points perpendicular from the retention tab into the channel; and
a wedge clip that is selectively received by the opening of the attachment portion.

2. The solar module bracket of claim 1, wherein the central panel has a length and a width, wherein the central panel is longer than the central panel is wide.

3. The solar module bracket of claim 1, wherein each of the first side panel and the second side panel has a top edge, and wherein the top edge of each side panel has a flange.

4. The solar module bracket of claim 3, wherein the flange is perpendicular to the respective side panel.

5. The solar module bracket of claim 4, wherein the flange abuts a portion of the back rail where the solar module bracket is engaged on the back rail.

6. The solar module bracket of claim 1, wherein the central panel has free edges on either terminal end.

7. The solar module bracket of claim 6, wherein each free edge has an L-shaped flange extending outwardly therefrom.

8. The solar module bracket of claim 1, wherein the second side panel has an attachment portion that is aligned with the attachment portion of the first side panel.

9. The solar module bracket of claim 8, wherein when the back rail is positioned in the solar module bracket, each opening of the attachment portion on the first side panel and the second side panel is aligned with mounting slots formed in the back rail.

10. The solar module bracket of claim 9, wherein the aligned openings and mounting slots receive the wedge clip that passes through both the openings in the side panels and the mounting slots in the back rail to secure the solar panel module within the solar module bracket.

11. The solar module bracket of claim 1, wherein the solar module bracket includes two pairs of attachment portions, disposed adjacent to terminal ends of the bracket.

12. The solar module bracket of claim 1, wherein the wedge clip is formed from a unibody construction, where the wedge clip includes a first arm and a second arm that are spaced apart from one another.

13. The solar module bracket of claim 12, wherein the wedge clip is tapered such that the wedge clip gets wider from one end to the other, creating a gradual increase in cross-sectional area along the length of the wedge clip, with a longitudinal split formed by a spacing between the first arm and the second arm increasing along the length of the wedge clip.

14. The solar module bracket of claim 13, wherein the wedge clip is compressible, and when the wedge clip is compressed, the first arm and the second arm are brought together, effectively closing the longitudinal split and reducing the overall width of the wedge clip for insertion through aligned openings and mounting slots.

15. The solar module bracket of claim 14, wherein the wedge clip is self-biased so when the wedge clip is not compressed, the wedge clip automatically returns to the tapered shape due to inherent spring properties of the material, with the first arm and the second arm returning to spaced-apart positions.

16. The solar module bracket of claim 12, wherein adjacent to a connected end of the wedge clip, the first arm has a spring tab that extends at an angle outwardly from the first arm.

17. The solar module bracket of claim 16, wherein the spring tab is configured to selectively deform elastically when subjected to compressive forces during insertion through the opening, but automatically returns to an extended configuration when the spring tab clears the opening.

18. The solar module bracket of claim 12, wherein on an open side of the wedge clip, each end of the first arm and second arm has retention flanges that extend substantially orthogonal to each of the first arm and second arm.

19. The solar module bracket of claim 1, wherein:
the central panel having a length and a width, wherein the central panel is longer than the central panel is wide;
each of the first side panel and the second side panel having a top edge, wherein the top edge of each side panel has a flange that is perpendicular to the respective side panel, and wherein the flange abuts a portion of the back rail where the solar module bracket is engaged on the back rail;
the central panel having free edges on either terminal end, each free edge having an L-shaped flange extending outwardly therefrom;
the second side panel having an attachment portion that is aligned with the attachment portion of the first side panel, wherein the attachment portion includes a retention tab and an opening, wherein an edge of the retention tab is cut out from the side panel and at a free end adjacent to the opening there is a deflection arm that points perpendicular from the retention tab into the channel;
wherein when the back rail is positioned in the solar module bracket, each opening of the attachment portion on the first side panel and the second side panel is aligned with mounting slots formed in the back rail;
a mounting portion projecting downwardly from the central panel, the mounting portion including a pair of landings separated by an arcuate portion, wherein the arcuate portion has dimensions that match those of a torque tube such that the arcuate portion rests on the torque tube, and wherein each of the landings has apertures that each receive an end of a U-bolt;
wherein the aligned openings and mounting slots receive the wedge clip that passes through both the openings in the side panels and the mounting slots in the back rail to secure the solar panel module within the solar module bracket; and
wherein the wedge clip is formed from a unibody construction with a first arm and a second arm that are spaced apart from one another, wherein the wedge clip is tapered such that the wedge clip gets wider from one end to the other with a longitudinal split formed by a spacing between the first arm and the second arm, and wherein the wedge clip can be compressed together when pressure is applied and automatically returns to a tapered shape due to inherent spring properties of the material.

20. A method for mounting a solar panel module, comprising:
providing a solar module bracket including:
a central panel, a first side panel, and a second side panel that together form a U-shaped configuration, wherein the first side panel and the second side panel each extend from an edge of the central panel and are disposed along a length of the central panel, and wherein the central panel, first side panel, and second side panel collectively define a channel;
the first side panel having an attachment portion, wherein the attachment portion includes a retention tab and an opening, wherein an edge of the retention tab is cut out from the side panel and at a free end adjacent to the opening there is a deflection arm that points perpendicular from the retention tab into the channel; and
a wedge clip that is selectively received by the opening of the attachment portion;
providing a tracker torque tube;
providing a U-bolt and fasteners for securing the solar module bracket to the tracker torque tube;
providing a solar panel module having a back rail with mounting slots;
positioning the solar module bracket adjacent to the tracker torque tube such that a mounting portion that projects downwardly from the central panel receives the tracker torque tube;
disposing the U-bolt around the tracker torque tube and through apertures in landings of the mounting portion;
securing the U-bolt to the solar module bracket using fasteners to mount the bracket to the tracker torque tube;
placing the solar panel module into the channel of the solar module bracket such that the back rail is positioned within the channel;
sliding the solar panel module laterally or horizontally within the solar module bracket to engage a deflection arm of the attachment portion with a mounting slot on the back rail, thereby temporarily securing the solar panel module to the solar module bracket; and
inserting the wedge clip through the opening of the solar module bracket and the mounting slot of the back rail to secure the solar panel module within the solar module bracket.
